(19) United States
(12) Patent Application Publication
(10) Pub. No.: US 2020/0394637 A1
(43) Pub. Date: Dec. 17, 2020

(54) REGISTRATION APPARATUS, REGISTRATION METHOD, AND NON-TRANSITORY STORAGE MEDIUM

(71) Applicant: NEC CORPORATION, Tokyo (JP)

(72) Inventors: Soma SHIRAISHI, Tokyo (JP); Kota IWAMOTO, Tokyo (JP); Hideo YOKOI, Tokyo (JP); Tsugunori TAKATA, Tokyo (JP); Emi KITAGAWA, Tokyo (JP)

(73) Assignee: NEC CORPORATION, Tokyo (JP)

(21) Appl. No.: 16/971,972

(22) PCT Filed: Feb. 23, 2018
(86) PCT No.: PCT/JP2018/006719

§ 371 Date: Aug. 21, 2020

(51) Int. Cl. G06Q 20/20; G07G 1/00; G07G 1/12

(52) U.S. Cl. CPC G06Q 20/208; G06K 2209/17; G07G 1/12; G07G 1/0063

(57) ABSTRACT

The invention provides a registration apparatus (10) including: an image acquisition unit (11) that acquires an image obtained by imaging a placement surface of a table, on which a product is placed; an analysis unit (12) that recognizes the product included in the image; a registration unit (14) that registers the recognized product as a checkout target; and an output unit (13) that displays information corresponding to progress of analysis of the image in the analysis unit (12) on the table.

### TECHNICAL FIELD

The present invention relates to a registration apparatus, a registration method, and a program.

### BACKGROUND ART

Patent Document 1 discloses a product registration apparatus that images a product to be a checkout target and, recognizes the product in the image through image analysis and registers the product.

Patent Document 2 discloses a display control apparatus that decides a display region of a display object displayed on a display surface according to information of a real object on the display surface. The display control apparatus can recognize a type of tableware placed on a dining table and can output a display effect and sound according to the type.

Patent Document 3 discloses a user terminal that receives an image of products generated by a camera, displays the image, and receives specification of a product from among the displayed products.

### RELATED DOCUMENT

### Patent Document

[Patent Document 1] Japanese Unexamined Patent Publication No. 2016-62545

[Patent Document 2] International Publication No. WO2015/098189

[Patent Document 3] Japanese Unexamined Patent Publication No. H03-143185

### SUMMARY OF THE INVENTION

### Technical Problem

In the technique for imaging a product to be a checkout target and, recognizing the product in the image through image analysis and registering the product, there is a problem in that a checkout operator hardly recognizes the progress of the image analysis. The invention addresses the problem of, in a technique for recognizing a product to be a checkout target through image analysis and registering the product, enabling a checkout operator to recognize the progress of the image analysis.

### Solution to Problem

According to the invention, there is provided a registration apparatus including:

an image acquisition unit that acquires an image obtained by imaging a placement surface of a table, on which a product is placed;

an analysis unit that recognizes the product included in the image;

a registration unit that registers the recognized product as a checkout target; and

an output unit that displays information corresponding to progress of analysis of the image in the analysis unit on the table.

According to the invention,

there is provided a registration method executed by a computer, the method including:

an image acquisition step of acquiring an image obtained by imaging a placement surface of a table, on which a product is placed;

an analysis step of recognizing the product included in the image;

a registration step of registering the recognized product as a checkout target; and

an output step of displaying information corresponding to progress of analysis of the image in the analysis step on the table.

According to the invention,

there is provided a program that causes a computer to function as:

an image acquisition unit that acquires an image obtained by imaging a placement surface of a table, on which a product is placed;

an analysis unit that recognizes the product included in the image;

a registration unit that registers the recognized product as a checkout target; and

an output unit that displays information corresponding to progress of analysis of the image in the analysis unit on the table.

### Advantageous Effects of Invention

According to the invention, in a technique for recognizing a product to be a checkout target through image analysis and registering the product, it is possible to enable a checkout operator to recognize the progress of the image analysis.

### BRIEF DESCRIPTION OF THE DRAWINGS

The above-described object and other objects, features, and advantages will become apparent from preferable example embodiments described below and the accompanying drawings.

FIG. 1 is a diagram showing an example of the hardware configuration of a registration apparatus of the present example embodiment.

FIG. 2 is a diagram showing an example of a functional block diagram of the registration apparatus of the present example embodiment.

FIG. 3 is a diagram schematically showing a camera and a table that are used in checkout processing using the registration apparatus of the present example embodiment.

FIG. 4 is a flowchart showing an example of a flow of processing of the registration apparatus of the present example embodiment.

FIG. 5 is a diagram schematically showing an example of information that is displayed on the table by the registration apparatus of the present example embodiment.

FIG. 6 is a diagram schematically showing an example of information that is displayed on the table by the registration apparatus of the present example embodiment.

FIG. 7 is a diagram schematically showing an example of information that is displayed on the table by the registration apparatus of the present example embodiment.

### DESCRIPTION OF EMBODIMENTS

### First Example Embodiment

First, the outline of a registration apparatus of the present example embodiment will be described. The registration apparatus of the present example embodiment is used for checkout processing at a store that sells products. The registration apparatus may be a so-called point of sales (POS) register. The registration apparatus may be an apparatus on the premise of being operated by a salesperson or may be an apparatus on the premise of being operated by a customer.

In the checkout processing using the registration apparatus, a table on which a product to be a target of the checkout processing is placed, and a camera that images a placement surface of the table are prepared. In the checkout processing, a checkout operator (salesperson, customer, or the like) places a product to be a checkout target on the placement surface of the table. In a case where an image generated by the camera is acquired, the registration apparatus analyzes the image and recognizes the product included in the image. Then, the registration apparatus registers the recognized product as the product to be a checkout target.

It should be noted that the registration apparatus has a function of enabling the checkout operator to recognize the progress of the image analysis. Specifically, the registration apparatus displays information corresponding to the progress on the table according to the progress of the image analysis. A plurality of kinds of information corresponding to the progress are different from one another.

With the registration apparatus of the present example embodiment, the checkout operator can recognize the progress of the image analysis based on information displayed on the table.

Next, the configuration of the registration apparatus of the present example embodiment will be described in detail. First, an example of the hardware configuration of the registration apparatus will be described. Functions provided in the registration apparatus are implemented by any combination of hardware and software of any computer centering on a central processing unit (CPU), a memory, a program loaded on the memory, a storage unit (capable of storing programs stored in advance at the time of shipment of the apparatus as well as programs downloaded from a storage medium, such as a compact disc (CD), or a server on the Internet), such as a hard disk that stores the program, and an interface for network connection. In addition, those skilled in the art can understand that various modification examples can be made to the implementation method and the apparatus.

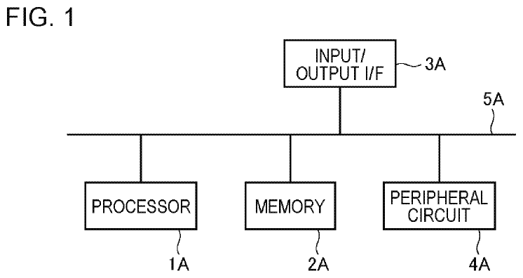

FIG. 1 is a block diagram illustrating the hardware configuration of the registration apparatus. As shown in FIG. 1, the registration apparatus has a processor 1A, a memory 2A, an input/output interface 3A, a peripheral circuit 4A, and a bus 5A. In the peripheral circuit 4A, various modules are included. It should be noted that the peripheral circuit 4A may not be provided.

The bus 5A is a data transmission path through which the processor 1A, the memory 2A, the peripheral circuit 4A, and the input/output interface 3A transmit and receive data to and from one another. The processor 1A is, for example, an arithmetic processing unit, such as a central processing unit (CPU) or a graphics processing unit (GPU). The memory 2A is, for example, a memory, such as a random access memory (RAM) or a read only memory (ROM). The input/output interface 3A includes an interface through which information is acquired from an input apparatus (for example: a keyboard, a mouse, a microphone, or the like), an external apparatus, an external server, or an external sensor, an interface through which information is output to an output apparatus (for example: a display, a speaker, a printer, an emailer, or the like), an external apparatus, or an external server, and the like. The processor 1A can issue a command to each module and performs an arithmetic operation based on the arithmetic results of the modules.

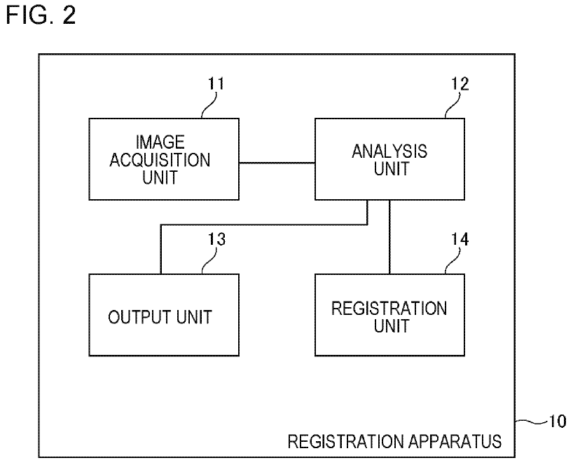

FIG. 2 shows an example of a functional block diagram of a registration apparatus 10. As shown in the drawing, the registration apparatus 10 has an image acquisition unit 11, an analysis unit 12, an output unit 13, and a registration unit 14.

The image acquisition unit 11 acquires an image obtained by imaging the placement surface of the table on which a product is placed. As described above, in the checkout processing using the registration apparatus 10, the table on which the product to be a target of the checkout processing is placed, and the camera that images the placement surface of the table are prepared. The image acquisition unit 11 acquires an image generated by the camera. The camera may generate a moving image (a plurality of images), and the image acquisition unit 11 may acquire the moving image from the camera.

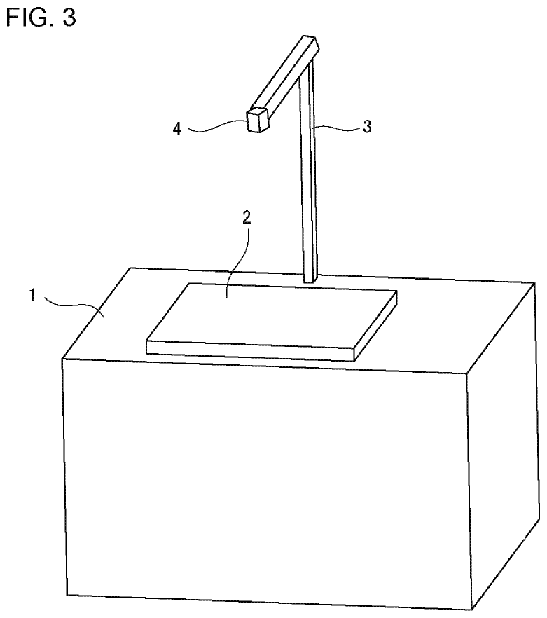

FIG. 3 schematically shows an example of the table and the camera. In the drawing, a table 1, a member 2, a support pillar 3, and a camera 4 are shown. The member 2 is positioned on an upper surface of the table 1 and forms a part of the table 1. An exposed surface of the member 2 is a placement surface on which a product is placed. It should be noted that the member 2 may be a display or may be other members. The camera 4 is attached to the support pillar 3 and images the exposed surface of the member 2 from above. An image generated by the camera 4 is transmitted to the registration apparatus 10 (not shown) through communication in a wired or wireless manner.

Returning to FIG. 2, the analysis unit 12 analyzes the image acquired by the image acquisition unit 11 and recognizes the product included in the image. The analysis unit 12 can recognize the product using a pattern matching technique or the like.

For example, the analysis unit 12 detects an object included in the image (object detection) using techniques, such as image binarization and contour extraction. Thereafter, the analysis unit 12 collates a feature (a feature of a region where the object in the image is present) of an appearance of the detected object appearing in the image with a feature of an appearance of each of a plurality of products registered in advance, thereby determining what product the object is (product recognition). For example, the analysis unit 12 may determine a product of which similarity in appearance to the object is the highest, or a product of which similarity in appearance to the object is the highest and is equal to or greater than a reference value. As the feature of the appearance of the product, although a color, surface roughness, a shape, or the like is exemplified, the invention is not limited thereto.

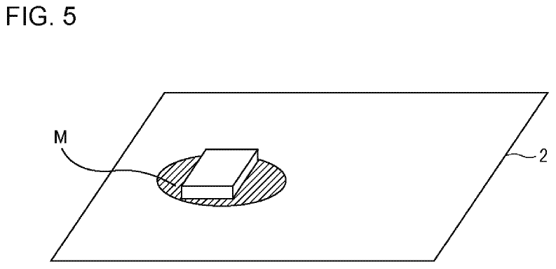

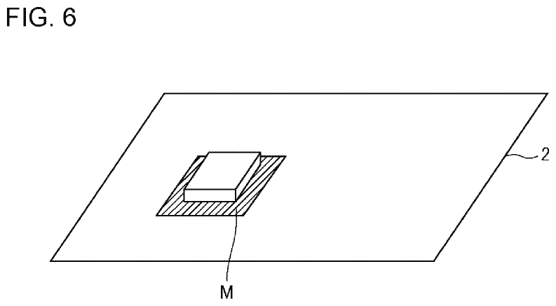

The output unit 13 displays information corresponding to the progress of the image analysis in the analysis unit 12 on the table (for example: the placement surface of the table). A plurality of kinds of information corresponding to the progress are different from one another. For example, the output unit 13 may display a first mark M (for example: circle or the like) on the table as shown in FIG. 5 with completion of object detection, and may display a second mark M (for example: quadrangle or the like) on the table as shown in FIG. 6 with completion of product recognition. It should be noted that, although examples where information is displayed on the table with completion of object detection and completion of product recognition have been described, a configuration may be made in which information is displayed on the table as the image analysis reaches other states. Information to be displayed is not limited to the mark, and may be other kinds of information, such as letters, numbers, pictures, or mascot characters. A display aspect (for example: color or shade) of the mark may be different according to the progress of the image analysis. For example, the output unit 13 may display a mark of a first color in a case where recognition is made by the analysis unit 12 that an object is placed on the table, and may display a mark of a second color in a case where the product is recognized by the analysis unit 12.

In a case where a display is provided as a part of the table, the output unit 13 can cause the display to display information corresponding to the progress of the image analysis. For example, as described referring to FIG. 3, in a case where the placement surface on which a product is placed is constituted of a display (member 2), the output unit 13 can cause the display (member 2) to display information corresponding to the progress of the image analysis. In addition, the output unit 13 may project information onto the table using a projection apparatus.

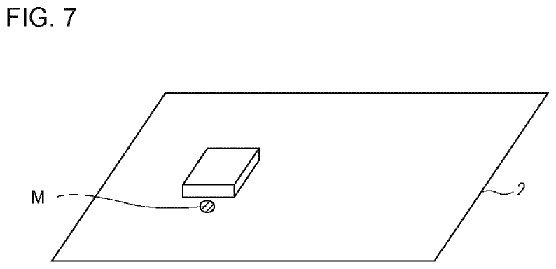

The output unit 13 can display information corresponding to the progress of the image analysis at a position corresponding to a placed position of an object. For example, information (mark M) may be displayed so as to surround the placed position of the object as shown in FIGS. 5 and 6 or information (mark M) may be displayed to be close to the placed position of the object as shown in FIG. 7. For example, the output unit 13 holds a conversion rule for converting “coordinates of an image” into “coordinates of a display region of the display constituting the placement surface of the table” in advance. Then, the output unit 13 converts a position (coordinates) of an object in the image into coordinates of the display region of the display based on the conversion rule and displays information, for example, so as to surround the converted position or to be close to the position.

Similarly, the output unit 13 may hold a conversion rule for converting “coordinates of an image” into “coordinates of a projection region of a projection apparatus” in advance. Then, the output unit 13 may convert a position (coordinates) of an object in the image into coordinates of a projection region of the projection apparatus based on the conversion rule and may display information, for example, so as to surround the converted position or to be close to the position.

The coordinates of the image are indicated by a coordinate system in which any position in the image is determined as the origin and any directions are determined as the x-axis direction and the y-axis direction. The coordinates of the display region of the display are indicated by a coordinate system in which any position in the display region is determined as the origin and any directions are determined as the x-axis direction and the y-axis direction. The coordinates of the projection region of the projection apparatus are indicated by a coordinate system in which any position in the projection region is determined as the origin and any directions are determined as the x-axis direction and the y-axis direction.

The registration unit 14 registers the product recognized by the analysis unit 12 as a checkout target. For example, the registration unit 14 acquires product information of the product recognized by the analysis unit 12 from a product master and registers at least a part of the acquired product information in the registration apparatus 10. The product information includes a price, a product name, a product code, and the like.

With the registration apparatus 10 of the present example embodiment described above, the product placed on the table can be recognized through the image analysis, and the recognized product can be registered as a checkout processing target. With the registration apparatus 10, a registration operation of a product is performed efficiently.

The registration apparatus 10 can display information corresponding to the progress on the table according to the progress of the image analysis. It should be noted that a plurality of kinds of information corresponding to the progress are different from one another. For example, the registration apparatus 10 may display the first mark (for example: circle or the like) on the table with completion of object detection, and may display the second mark (for example: quadrangle or the like) on the table with completion of product recognition. With the registration apparatus 10, the checkout operator can recognize the progress of the image analysis based on information displayed on the table.

### Second Example Embodiment

A registration apparatus 10 of the present example embodiment can display information on the table at a timing different from the first example embodiment. Hereinafter, description will be provided in detail.

An example of the hardware configuration of the registration apparatus 10 is the same as in the first example embodiment.

An example of a functional block diagram of the registration apparatus 10 is shown in FIG. 2 as in the first example embodiment. The configurations of the image acquisition unit 11 and the registration unit 14 are the same as in the first example embodiment.

As in the first example embodiment, the analysis unit 12 analyzes the image acquired by the image acquisition unit 11 and recognizes the product included in the image. The analysis unit 12 can execute “detection of an object”, “recognition that the object is placed on the table”, and “determination about what product the object placed on the table is” in this order.

The detection of the object can be implemented using all techniques, such as image binarization and contour extraction.

The recognition that the object is placed on the table can be implemented, for example, as follows. First, information indicating a display region of the placement surface of the table in the image is held in the analysis unit 12. The display region may be indicated by coordinates of a coordinate system in which any point in the image is determined as the origin and any directions are determined as the x axis and the y axis (for example: in a case where the display region has a polygonal shape, coordinates of the vertex). A part in the image may be the display region of the placement surface of the table or the whole image may be the display region of the placement surface of the table. It is assumed that an installation position of the table, an installation position of the camera, an orientation of the camera, and the like are fixed, and a relatively positional relationship between the table and the camera, and the like are constant. Then, in a case where detection is made that movement of an object present in the display region of the placement surface of the table is stopped for a predetermined time or more, the analysis unit 12 may recognize the object is placed on the table.

The determination (product recognition) about what product the object placed on the table is implemented by collating a feature (a feature of the region in the image where the object is present) of an appearance of the detected object appearing in the image with the feature of the appearance of each of a plurality of products registered in advance. For example, the analysis unit 12 may determine a product of which similarity in appearance to the object is the highest, or a product of which similarity in appearance to the object is the highest and is equal to or greater than a reference value. As the feature of the appearance of the product, although a color, surface roughness, a shape, or the like is exemplified, the invention is not limited thereto.

The output unit 13 displays information indicating recognition is made by the analysis unit 12 that an object is placed on the table or determination is made about what product the object placed on the table is. For example, in a case where recognition is made by the analysis unit 12 that an object is placed on the table, the output unit 13 displays first information corresponding to the state on the table. Furthermore, determination is made by the analysis unit 12 about what product the object placed on the table is, the output unit 13 displays second information corresponding to the state on the table. The first information and the second information are different from each other.

It should be noted that, in a case where the object is detected by the analysis unit 12, the output unit 13 may display information (information different from the first information and the second information) corresponding to the state on the table.

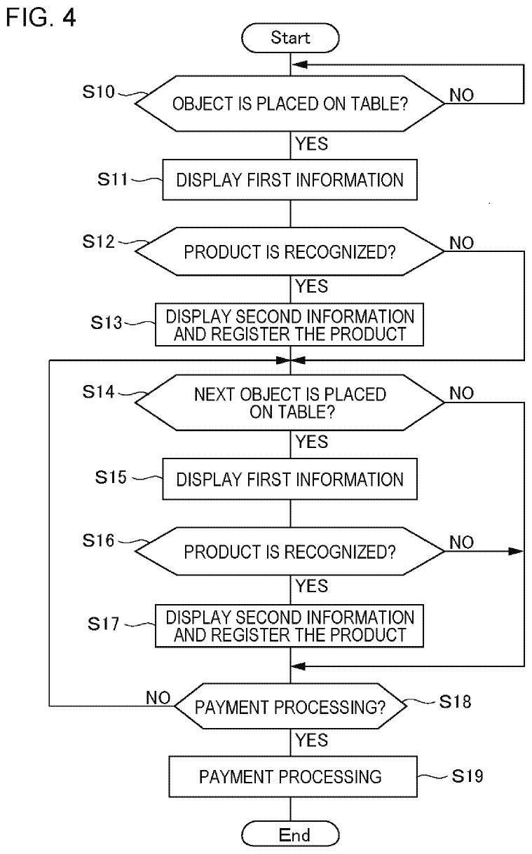

Next, an example of a flow of processing of the registration apparatus 10 of the present example embodiment will be described referring to a flowchart of FIG. 4.

In a case where the processing is started, the image acquisition unit 11 starts acquisition of an image from the camera. Then, the analysis unit 12 starts analysis of the image.

In a case where recognition is made by the analysis unit 12 that an object is placed on the table (in S10, Yes), the output unit 13 displays the first information corresponding to the state on the table (S11). The output unit 13 displays the first information at the position corresponding to the placed position of the object. It should be noted that, while recognition is not made by the analysis unit 12 that an object is placed on the table (in S10, No), the first information is not displayed on the table.

Thereafter, in a case where determination is made by the analysis unit 12 about what product the object is (in S12, Yes), the output unit 13 displays the second information corresponding to the state (S13). The output unit 13 displays the second information at the position corresponding to the placed position of the object. In S13, the registration unit 14 registers the determined product as a checkout target. In a case where determination is not made by the analysis unit 12 about what product the object placed on the table is (in S12, No), the second information is not displayed on the table.

It should be noted that the output unit 13 may continue the display of the first information until displaying the second information is displayed. Then, in a case where determination is made by the analysis unit 12 about what product the object is (in S12, Yes), the display of the first information may end accordingly, and the second information may be displayed instead. Thereafter, the output unit 13 may continue the display of the second information until the object leaves from the table or until there is an input for payment processing. As another example, the output unit 13 may display the first information and the second information for a predetermined time, and may end the display of the first information and the second information as the predetermined time has elapsed.

Thereafter, in a case where recognition is made by the analysis unit 12 that a next object is placed on the table (in S14, Yes), the output unit 13 displays the first information corresponding to the state on the table (S15). The output unit 13 displays the first information at the position corresponding to the placed position of the object. Thereafter, in a case where determination is made by the analysis unit 12 about what product the object is (in S16, Yes), the output unit 13 displays the second information corresponding to the state on the table (S17). The output unit 13 displays the second information at the position corresponding to the placed position of the object. In S17, further, the registration unit 14 registers the determined product as a checkout target. It should be noted that, in a case where a plurality of objects are placed on the table, a plurality of kinds of the first information may be displayed on the table, a plurality of kinds of the second information may be displayed on the table, or both of the first information and the second information may be displayed on the table.

In a case where new recognition and determination in S14 and S16 are not made by the analysis unit 12 (in S14, No and in S16, No), and in a case where there is an input for payment processing (in S18, Yes), the registration apparatus 10 executes the payment processing (S19). For example, the registration apparatus 10 may receive an input of cash as payment of a total amount of payment computed based on the products already registered and may output change or a receipt as needed. The registration apparatus 10 may receive an input of a credit card, may perform communication with a system of a credit card company, and may perform settlement processing. The registration apparatus 10 may transmit information (information indicating the registered product, a total amount of payment, or the like) for the payment processing to other payment apparatuses.

With the registration apparatus 10 of the present example embodiment described above, the same advantageous effects as in the first example embodiment can be achieved. Furthermore, with the registration apparatus 10 of the present example embodiment, different kinds of information from each other can be displayed on the table with recognition that the object is placed on the table and product recognition.

With the registration apparatus 10 of the present example embodiment, the checkout operator can recognize, based on information displayed on the table, that the object being placed on the table is recognized. Furthermore, the checkout operator can recognize that the product is recognized. Since the checkout operator can recognize the progress of the image analysis, the checkout operator can proceed with a registration operation without feeling uneasy.

### Third Example Embodiment

In a registration apparatus 10 of the present example embodiment, information displayed on the table when a product is recognized is different from the first and second example embodiments. Hereinafter, description will be provided in detail.

An example of the hardware configuration of the registration apparatus 10 is the same as in the first and second example embodiments.

An example of a functional block diagram of the registration apparatus 10 is shown in FIG. 2 as in the first and second example embodiments. The configurations of the image acquisition unit 11 and the registration unit 14 are the same as in the first and second example embodiments.

The analysis unit 12 determines a product category of a recognized product. Other configurations of the analysis unit 12 are the same as in the first and second example embodiments. For example, product category information indicating a product category for each product may be held in the analysis unit 12 in advance. Then, in a case where a product is recognized through image analysis, the analysis unit 12 determines the product category of the recognized product with reference to the product category information.

The output unit 13 makes the second information, which is displayed on the table when determination is made by the analysis unit 12 about what product the object placed on the table is, different according to the product category of the determined product. For example, the output unit 13 may display a star mark on the table when “food” is determined, and may display a triangle mark on the table when “everyday goods” is determined. Other configurations of the output unit 13 are the same as in the first and second example embodiments.

With the registration apparatus 10 of the present example embodiment described above, the same advantageous effects as in the first and second example embodiments can be achieved. Furthermore, with the registration apparatus 10 of the present example embodiment, the checkout operator can recognize not only that the product is recognized but also a recognition content (product category) based on information displayed on the table. Based on this, the checkout operator can confirm whether or not the recognition content is not wrong.

### Fourth Example Embodiment

In a registration apparatus 10 of the present example embodiment, information displayed on the table when a product is recognized is different from the first and second example embodiments. Hereinafter, description will be provided in detail.

An example of the hardware configuration of the registration apparatus 10 is the same as in the first and second example embodiments.

An example of a functional block diagram of the registration apparatus 10 is shown in FIG. 2 as in the first and second example embodiments. The configurations of the image acquisition unit 11 and the registration unit 14 are the same as in the first and second example embodiments.

The analysis unit 12 outputs reliability of a recognition result that a product is recognized. The reliability may be similarity (similarity between the recognized product and the object included in the image) computed by pattern matching. Other configurations of the analysis unit 12 are the same as in the first and second example embodiments.

The output unit 13 makes information, which is displayed on the table when recognition is made by the analysis unit 12 about what product the object placed on the table is, different according to the reliability of the recognition result. For example, the reliability may be divided into a plurality of ranks, such as “high”, “middle”, and “low”, and information may be prepared for each rank. For example, the output unit 13 may display a double circle mark on the table in a case where the reliability is “high”, may display a circle mark on the table in a case where the reliability is “middle”, and may display an x mark on the table in a case where the reliability is “low”. Other configurations of the output unit 13 are the same as in the first and second example embodiments.

With the registration apparatus 10 of the present example embodiment described above, the same advantageous effects as in the first and second example embodiments can be achieved. Furthermore, with the registration apparatus 10 of the present example embodiment, the checkout operator can recognize not only that the product is recognized but also the reliability of product recognition, based on information displayed on the table. The checkout operator can confirm whether or not the recognition content is not wrong in a case where the reliability is low. According to the present example embodiment, the checkout operator can confirm the recognition content only on a product having low reliability instead of confirming whether or not the recognition content is not wrong on all products. As a result, labor of an operation can be saved.

### Fifth Example Embodiment

A registration apparatus 10 of the present example embodiment can display information on the table at a timing different from the first to fourth example embodiments. Hereinafter, description will be provided in detail.

An example of the hardware configuration of the registration apparatus 10 is the same as in the first to fourth example embodiments.

An example of a functional block diagram of the registration apparatus 10 is shown in FIG. 2 as in the first to fourth example embodiments. The configurations of the image acquisition unit 11 and the registration unit 14 are the same as in the first to fourth example embodiments.

The analysis unit 12 continuously analyzes a plurality of frames (images) included in a moving image. Then, after a first product that has not been recognized in a frame immediately before a first frame is recognized in the first frame, in a case where a recognition result on a frame after the first frame satisfies a predetermined condition, the analysis unit 12 decides a recognition result that the first product is included in the image. The predetermined condition may be a condition that the first product is recognized continuously in M frames after the first product is recognized in the first frame (where M is an integer equal to or greater than one). Other configurations of the analysis unit 12 are the same as in the first to fourth example embodiments.

The output unit 13 displays third information on the table in a case where the first product is recognized in the first frame by the analysis unit 12. Then, the output unit 13 displays the second information on the table in a case where determination is made by the analysis unit 12 that the predetermined condition is satisfied. The third information is different from information (for example: first information and second information) corresponding to other states of the image analysis. Other configurations of the output unit 13 are the same as in the first to fourth example embodiments.

After the recognition result that the first product is included in the image is decided, the registration unit 14 registers the first product as a checkout target.

With the registration apparatus 10 of the present example embodiment described above, the same advantageous effects as in the first to fourth example embodiments can be achieved. Furthermore, with the registration apparatus 10 of the present example embodiment, the recognition result of the product included in the image can be decided based on not only an analysis result on one frame but also analysis results on a plurality of frames. As a result, the reliability of the analysis result can be increased.

With the registration apparatus 10 of the present example embodiment, the checkout operator can recognize, based on information displayed on the table, the progress of processing for deciding the recognition result of the product included in the image based on the analysis results on a plurality of frames. As a result, the checkout operator can recognize the state of the image analysis in more detail.

Here, a modification example that can be applied to all example embodiments will be described. The registration apparatus 10 may have a switching unit that turns on and off the display of information on the table in the output unit 13. The switching unit can switch on and off according to a user input. In a case where the display of information on the table in the output unit 13 is turned on, the output unit 13 displays information corresponding to the progress on the table according to the progress of analysis of the image in the analysis unit 12. In contrast, in a case where the display of information on the table in the output unit 13 is turned off, the output unit 13 does not display information corresponding to the progress of analysis of the image in the analysis unit 12 on the table. A customer or a store that feels troublesome in display of information on the table can operate the registration apparatus 10 and can perform off setting, thereby avoiding the display of information on the table. In this way, according to the modification example, a user-friendly configuration can be achieved.

It should be noted that the switching unit that turns on and off the display of information on the table in the output unit 13 may have a function of turning on and off display of information relating to a part of product groups. For example, the switching unit may have a function of displaying information on the table in a case where a product (perishable food, medicine, or the like) belonging to a specific product category is identified. Alternatively, in regard to the product belonging to the specific product category, display of information on the table may be restricted. The switching unit may have a function of displaying information on the table in regard to a product of a predetermined price or more or may have a function of not displaying information on the table in regard to a product of a predetermined price or less. The switching unit may be a physical switch, or a button of the switching unit may be displayed on the table on which information is displayed.

Another modification example that can be applied to all example embodiments will be described. In a case where recognition is made by the analysis unit 12 that an object is placed on the table, but determination is not made about what product the object is (in a case where a product is not recognized), the output unit 13 may display information indicating the effect on the table. The information is different from information (for example: first information, second information, and third information) corresponding to other states of the image analysis. A case where a product is not recognized may be, for example, a case where there is no product of which similarity is equal to or greater than the reference value. According to the modification example, the checkout operator can recognize, based on information displayed on the table, a state in which an object is detected but a product is not recognized. As a result, the state of the image analysis can be recognized in detail.

Another modification example that can be applied to all example embodiments will be described. In a case where a product that has been recognized by the analysis unit 12 (in the fifth example embodiment, a recognition result is decided), and (hereinafter, referred to as a “registered product”) registered by the registration unit 14 is not detected in a frame image (for example: a frame image after a frame image where the product has been recognized or a frame image after a frame image where the recognition result is decided) after the registration, the output unit 13 displays information indicating the effect at the original placed position (the placed position determined from a last frame image in which the product has been detected) of the registered product. The output unit 13 may change an aspect of information displayed at the original placed position according to a continuous time for which the product is not detected (the number of continuous frames where the product is not detected). For example, the output unit 13 may display predetermined information (for example: predetermined mark) at the original placed position, and the shade of the information may be gradually made light as the continuous time increases. In addition, the output unit 13 may gradually make the shade of information (for example: predetermined mark), which is displayed at the original placed position while the registered product is being detected, light as the continuous time increases.

The placed product may temporarily not be detected due to hiding, noise, or the like. In a case where detection and nondetection are alternately occurs in continuous frames, information display is changed discontinuously, and the checkout operator hardly recognizes a recognition result state. According to the modification example, such a problem can be restrained.

Hereinafter, examples of reference embodiments will be added below.

1. A registration apparatus including:

an image acquisition unit that acquires an image obtained by imaging a placement surface of a table, on which a product is placed;

an analysis unit that recognizes the product included in the image;

a registration unit that registers the recognized product as a checkout target; and

an output unit that displays information corresponding to progress of analysis of the image in the analysis unit on the table.

2. The registration apparatus described in 1, in which

the output unit displays first information on the table in a case where recognition is made by the analysis unit that an object is placed on the table.

3. The registration apparatus described in 1 or 2, in which

the output unit displays second information on the table in a case where the product is recognized by the analysis unit.

4. The registration apparatus described in 3, in which

the output unit makes the second information different according to a product category of the recognized product.

5. The registration apparatus described in 3, in which

the output unit makes the second information different according to reliability of a recognition result of the product.

6. The registration apparatus described in any one of 3 to 5, in which

after a first product that has not been recognized in a frame immediately before a first frame is recognized in the first frame, in a case where a recognition result on a frame after the first frame satisfies a predetermined condition, the analysis unit decides a recognition result that the first product is included in the image, and

the output unit displays third information on the table in a case where the first product is recognized in the first frame by the analysis unit, and displays the second information on the table in a case where determination is made by the analysis unit that the predetermined condition is satisfied.

7. The registration apparatus described in any one of 1 to 6, in which

the output unit displays a mark of a first color in a case where recognition is made by the analysis unit that an object is placed on the table, and displays a mark of a second color in a case where the product is recognized by the analysis unit.

8. The registration apparatus described in any one of 1 to 7, in which

in a case where an object unrecognizable as the product in the analysis unit is included in the image, the output unit displays, on the table, information indicating that an object is unrecognizable.

9. The registration apparatus described in any one of 1 to 8, in which

in a case where the product registered by the registration unit is not detected in an image after registration, the output unit displays predetermined information at a placed position determined from a last image in which the product is detected, and make shade of the information light as a continuous time for which the product is not detected increases.

10. A registration method executed by a computer, the method including:

an image acquisition step of acquiring an image obtained by imaging a placement surface of a table, on which a product is placed;

an analysis step of recognizing the product included in the image;

a registration step of registering the recognized product as a checkout target; and

an output step of displaying information corresponding to progress of analysis of the image in the analysis step on the table.

11. A program that causes a computer to function as:

an image acquisition unit that acquires an image obtained by imaging a placement surface of a table, on which a product is placed;

an analysis unit that recognizes the product included in the image;

a registration unit that registers the recognized product as a checkout target; and

an output unit that displays information corresponding to progress of analysis of the image in the analysis unit on the table.

1. A registration apparatus comprising:
at least one memory configured to store one or more instructions; and
at least one processor configured to execute the one or more instructions to:
acquire an image obtained by imaging a placement surface of a table, on which a product is placed;
recognize the product included in the image;
register the recognized product as a checkout target; and
display information corresponding to progress of analysis of the image for recognizing the product on the table.

2. The registration apparatus according to claim 1,
wherein the processor is further configured to execute the one or more instructions to display first information on the table in a case where recognition is made that an object is placed on the table.

3. The registration apparatus according to claim 1,
wherein the processor is further configured to execute the one or more instructions to display second information on the table in a case where the product is recognized.

4. The registration apparatus according to claim 3,
wherein the processor is further configured to execute the one or more instructions to make the second information different according to a product category of the recognized product.

5. The registration apparatus according to claim 3,
wherein the processor is further configured to execute the one or more instructions to make the second information different according to reliability of a recognition result of the product.

6. The registration apparatus according to claim 3,
wherein the processor is further configured to execute the one or more instructions to:
after a first product that has not been recognized in a frame immediately before a first frame is recognized in the first frame, in a case where a recognition result on a frame after the first frame satisfies a predetermined condition, decide a recognition result that the first product is included in the image, and
display third information on the table in a case where the first product is recognized in the first frame, and display the second information on the table in a case where determination is made that the predetermined condition is satisfied.

7. The registration apparatus according to claim 1,
wherein the processor is further configured to execute the one or more instructions to display a mark of a first color in a case where recognition is made that an object is placed on the table, and display a mark of a second color in a case where the product is recognized.

8. The registration apparatus according to claim 1,
wherein the processor is further configured to execute the one or more instructions to display, in a case where an object unrecognizable as the product is included in the image, on the table, information indicating that an object is unrecognizable.

9. The registration apparatus according to claim 1,
wherein the processor is further configured to execute the one or more instructions to display, in a case where the product registered is not detected in an image after registration, predetermined information at a placed position determined from a last image in which the product is detected, and make shade of the information light as a continuous time for which the product is not detected increases.

10. A registration method executed by a computer, the method comprising:
acquiring an image obtained by imaging a placement surface of a table, on which a product is placed;
recognizing the product included in the image;
registering the recognized product as a checkout target; and
displaying information corresponding to progress of analysis of the image for recognizing the product on the table.

11. A non-transitory storage medium storing a program that causes a computer to:
acquire an image obtained by imaging a placement surface of a table, on which a product is placed;
recognize the product included in the image;
register recognized product as a checkout target; and
display information corresponding to progress of analysis of the image for recognizing the product on the table.
